(19) United States
(12) Patent Application Publication
(10) Pub. No.: US 2025/0279523 A1
(43) Pub. Date: Sep. 4, 2025

(54) BATTERY SYSTEM WITH COMPENSATOR

(71) Applicant: SAMSUNG SDI CO., LTD., Yongin-si (KR)

(72) Inventors: Stefan REINPRECHT, Attendorf (AT); Wolfgang REINPRECHT, Attendorf (AT)

(21) Appl. No.: 18/742,476

(22) Filed: Jun. 13, 2024

(30) Foreign Application Priority Data
Mar. 4, 2024 (EP) 24161207.6

(51) Int. Cl. H01M 50/242; F16K 15/14; H01M 10/04; H01M 50/209; H01M 50/249

(52) U.S. Cl. CPC H01M 50/242; F16K 15/14; H01M 10/0481; H01M 50/209; H01M 50/249; H01M 2220/20

(57) ABSTRACT

A battery system includes: a battery cell stack including a plurality of battery cells accommodated in a compartment; and a compensator at an end of the battery cell stack to exert a pressing force on the battery cell stack. The compensator includes a flexible membrane coupled to a membrane carrier to define a variable volume that is configured to be filled with a fluid. The flexible membrane is configured to expand in response to a fluid pressure rising in the compensator and contract in response to the fluid pressure reducing in the compensator.

### CROSS-REFERENCE TO RELATED APPLICATION

The present application claims priority to and the benefit of European Patent Application Ser. No. 24/161,207.6, filed on Mar. 4, 2024, in the European Patent Office, the entire disclosure of which is incorporated herein by reference.

### BACKGROUND

### 1. Field

Aspects of embodiments of the present disclosure relate to a battery system with a compensator, a method of compensating the battery system, and a vehicle including the battery system.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of an electric motor and conventional combustion engine. Generally, an electric-vehicle battery (EVB, or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide only an irreversible conversion of chemical to electrical energy. Low-capacity rechargeable batteries are used as a power supply for small electronic devices, such as cellular phones, notebook computers, and camcorders, while high-capacity rechargeable batteries are used as a power supply for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, for example, a cylindrical or rectangular case, depends on the battery's intended purpose. Lithium-ion (and similar lithium polymer) batteries, widely known via their use in laptops and consumer electronics, dominate the most recent group of electric vehicles in development.

Rechargeable batteries may be used as a battery module formed of (or including) a plurality of unit battery cells coupled to each other in series and/or in parallel to provide high energy density, such as for motor driving of a hybrid vehicle. For example, the battery module may be formed by interconnecting the electrode terminals of the plurality of unit battery cells in an arrangement or configuration depending on a desired amount of power and to provide a high-power rechargeable battery.

Battery modules can be constructed in either a block design or in a modular design. In the block design, each battery is coupled to a common current collector structure and a common battery management system and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery management system (BMS) may protect the battery pack from operating outside its safe operating parameters. Operation outside the safe operating parameters may be indicated by over-current, over-voltage (e.g., during charging), over-temperature, under-temperature, over-pressure, and/or ground fault or leakage current detection. The BMS may prevent the battery from operating outside it's safe operating parameters by including an internal switch (e.g., a relay or solid-state device), which is opened if the battery is operated outside its safe operating parameters, requesting the devices to which the battery is connected to reduce or even terminate using the battery, and actively controlling the environment, such as through heaters, fans, air conditioning, and/or liquid cooling.

The mechanical integration of such a battery pack incorporates suitable mechanical connections between the individual components, for example, between battery modules and between them and a supporting structure of the vehicle. These connections are designed to remain functional and safe throughout the average service life of the battery system. Further, installation space and interchangeability standards must be considered, especially in mobile applications.

Mechanical integration of battery modules may be achieved by providing a carrier framework and by positioning the battery modules thereon. Fixing the battery cells or battery modules may be achieved by using fitted depressions in the framework or by mechanical interconnectors, such as bolts or screws. In another example, the battery modules may be confined by fastening side plates to lateral sides of the carrier framework. Cover plates may be fixed atop and below the battery modules.

The carrier framework of the battery pack is mounted to a carrying structure of the vehicle. When the battery pack is fixed at the bottom of the vehicle, the mechanical connection may be established from the bottom side by, for example, bolts passing through the carrier framework of the battery pack. The framework is generally made of aluminum or an aluminum alloy to lower the total weight of the assembly.

Battery systems include a plurality of battery cells and/or battery modules. The battery cells have a specific tolerance chain from the production itself. In a conventional arrangement, the battery cells are stacked, squeezed (or compressed), and then put into a compartment. However, over their lifetime and during charging or discharging, the width of battery cells increases (as referred to as swelling). This swelling applies additional force on the battery cells or compartment. Such swelling can lead to an early failure or to a reduction of the useable energy density of the entire battery system.

### SUMMARY

A compensation system, according to embodiments of the present disclosure, improves the application of the additional force caused by, for example, squeezing, which increases the lifetime of the battery cells and of the battery system.

The present disclosure is defined by the appended claims and their equivalents. The description that follows is subject to this limitation. Any disclosure lying outside the scope of the claims and their equivalents is intended for illustrative as well as comparative purposes.

According to an embodiment of the present disclosure, a battery system includes at least one battery cell stack including a plurality of battery cells accommodated in a compartment. The battery system includes at least one compensator, each located at an end of a respective battery cell stack. The compensator includes a flexible membrane coupled to a membrane carrier to define a variable volume that is filled with a fluid. The flexible membrane is configured to expand in response to a fluid pressure rising in the corresponding compensator and to contract in response to the fluid pressure reducing in the corresponding compensator. One compensator from among the at least one compensator is positioned at the end of the at least one battery cell stack to exert a pressing force on the at least one battery cell stack.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic side view of a battery system according to an embodiment;

FIG. 2 is a schematic top view of a battery system according to an embodiment;

FIG. 3 is a schematic cross-sectional view of a battery system including a compensator according to an embodiment;

FIG. 4 is a schematic cross-sectional view of a battery system including a compensator according to another embodiment;

FIG. 5 is a schematic cross-sectional view of a battery system including a compensator according to another embodiment;

FIG. 6 is a schematic side view of a battery system according to another embodiment; and

FIG. 7 is a flowchart describing a method of filling the battery system according to an embodiment.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements unless expressly described otherwise. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

According to an embodiment of the present disclosure, a battery system includes at least one battery cell stack, or a battery module including a plurality of battery cells, accommodated in a compartment and at least one compensator. Each of the at least one compensator is located at an end of a respective battery cell stack. The compensator includes a flexible membrane coupled to a membrane carrier to define a variable volume that is configured to be filled with a fluid. The flexible membrane is configured to expand in response to a fluid pressure rising in the compensator and to contract in response to the fluid pressure reducing in the compensator. One compensator from among the at least one compensator is positioned at the end or between ends of the battery cell stack to exert a pressing force on the corresponding battery cell.

The battery cell stack, including a plurality of battery cells, accommodated in a compartment may also be referred to as a battery module. The end may be an end plate of the compartment or an end portion separating two or more battery stacks in one compartment. Expanding may refer to increasing in volume and contracting may refer to decreasing in volume. The flexible membrane may be made of a flexible material, such as a flexible plastic or a flexible rubber material, but the present disclosure is not limited thereto. The membrane may have a thin skin or material layer. The membrane may be curved to at least partially define an internal space in which the fluid can be at least partially contained or collected.

The compression force generated by the flexible membrane filled with the fluid, which exerts pressure on the battery cell stack, can equalize tolerances in the battery cell stack and can equalize the swelling of the battery cells due to aging and/or due to charging/discharging. This is provided by the fluid, which exerts a pressing force acting onto the battery cell stack via the flexible membrane. The pressing force provided by the membrane provides an increase in battery lifetime of the battery system.

According to an embodiment, the battery system includes a plurality of compensators, which are fluid-connected with respect to each other by, for example, a fluid manifold. The fluid manifold may be a reservoir, a fluid channel, or a fluid plate. The fluid manifold may be part of a fluid flow circuit. Due to the fluid-connection between the compensators, the pressing force can be equalized between different battery stacks. Further, a filling or refilling process is simplified because not each compensator needs to be filled or refilled separately.

According to an embodiment, the fluid manifold is a cooling manifold or a cooling plate, which is fluid-connected with the plurality of compensators, and the fluid is a coolant. Thus, in this embodiment, existing structures of a battery system, namely the cooling plate included in a cooling circuit, can be used to provide the work medium for the compensator. Therefore, additional space is saved when using the coolant from the cooling plate. Thus, aspects of the battery system according to embodiments of the present disclosure can also be easily retrofitted into existing systems.

According to an embodiment, the compensator includes a fluid inlet including a one-way inflow valve configured to allow fluid to flow into the flexible membrane when a pressure difference across the fluid inlet is above a first opening pressure. The fluid outlet includes a one-way outflow valve configured to allow fluid to flow out of the flexible membrane when a pressure difference across the fluid outlet is above a second opening pressure. The first opening pressure of the one-way inflow valve is lower than the second opening pressure of the one-way outflow valve.

The opening pressure is a valve property and can be set in advance. The fluid inlet and the fluid outlet may be formed in the membrane carrier. With the above configuration including two different valves as describe above, a hysteresis effect can be created, which can stabilize the fluid flow variations. For example, the fluid in the flexible membrane may have a pressure (z) that is between the first opening pressure (x) and the second opening pressure (y). Then, the one-way inflow valve is opened and the one-way outflow valve is closed. In this case, a pressure force is applied to the at least one battery cell stack. When an overpressure (u>y) occurs due to swelling in the battery stack, the overpressure is relieved by the fluid outlet of the one-way outlet valve. Thus, the second opening pressure (y) acts as an overpressure protection mechanism because it defines an upper maximum pressure boundary. When the swelling decreases again, the pressure (u) will again reduce to within the hysteresis (x<z<y). Thus, suitable operating conditions can be set for the battery system including the two one-way valves. Even if the filling pressure (e.g., the ambient pressure) is not present, the battery stack remains under tension due to the lower boundary (e.g., the first opening pressure (x)) preventing an outflow of the fluid at lower pressure, thereby retaining a small amount of fluid in the membrane. This ensures that a residual pressure is exerted on the battery cell stack. Thus, a change in length during aging or charging/discharging can be compensated for, an overpressure protection feature is provided due to the pressure boundary, and a fluid retaining feature is provided due to the pressure boundary.

According to an embodiment, a normal filling or work pressure is between the first opening pressure and the second opening pressure. In a normal case, a pressure is applied to the at least one battery cell stack. This brings the battery system into a normal state/operation that benefits from the boundaries as described above. To provide stable operation conditions, the difference, that is, the hysteresis, of the first opening pressure (x) and the second opening pressure (y) may be relatively suitably large.

According to an embodiment, each of the inflow and outflow one-way valves includes a ball check valve including a spring and a ball member connected to the spring. The ball member is configured to close the respective fluid inlet or fluid outlet when the pressure difference is below the respective pressure difference. Thus, the opening pressures are set by the elastic spring. Correspondingly, the elastic properties (e.g., the stiffness) of the springs can be set or determined to define the relation of the first opening pressure (x) and the second opening pressure (y) as described above. For example, the stiffness of the spring of the one-way inflow valve may be set lower than the stiffness of the spring in the one-way outflow valve.

According to an embodiment, the fluid inlet and the fluid outlet are provided in a side wall of the membrane carrier. The fluid manifold includes a vertical connecting section, which is fluid connected to the fluid inlet and the fluid outlet. Thus, the configuration including two one-way valves can be easily integrated by using a side space. The vertical connecting section extends in a height direction of the battery cell stack.

According to an embodiment, the compensator includes a vertical inlet disposed between a planar fluid manifold and the flexible membrane. The vertical inlet includes a direct channel connecting the fluid manifold with the flexible membrane. Due to the direct channel to the interior of the flexible membrane, an overpressure pressure can be directly and automatically distributed. Further, due to the vertical inlet, lateral space can be reduced, which results in a more space efficient configuration. In addition, pressure regulation of overpressure in a battery stack is directly distributed over the entire fluid system without requiring a valve.

According to an embodiment, the vertical inlet has a cone shape. This provides a stable configuration because the cone shape ensures a tight seal when a pressure force is applied.

According to an embodiment, the membrane carrier includes two protruding portions protruding toward the battery cell stack. The portions are separated in a height direction (e.g., vertically). The flexible membrane is coupled to the membrane carrier so that the fluid is filled in the variable volume of the flexible membrane and in a fixed space formed between the horizontally protruding portions. This configuration may not only provide stable support for the flexible membrane but also allows for the contact area to the battery cell stack to be increased due to a lower curvature contact of the membrane. This can be used to achieve a more homogenous force acting onto the corresponding battery cell stack.

According to an embodiment, the end of the battery stack includes an end plate. The end plate is installed to be movable with respect to the at least one compensator. This allows a more homogeneous contact and a more effective pressure force transfer to the battery cell stack by guiding (or moving) the end plates.

According to an embodiment, a position control unit is configured to adjust the position of the end plate with respect to the compensator. Thus, a more homogenous pressure force across onto the battery cells of the battery cell stack may be achieved. For example, the contact area may be increased between the flexible membrane and the battery cell stack. The adjustment may be based on contact area measurements or pressing force determination.

According to an embodiment, one from among the at least one compensator is located between two ends of adjacent battery cell stacks to exert a pressing force on both battery cell stacks based on the fluid pressure in the flexible membrane. This allows for replacement of separators or a spacer between the battery cell stacks by the compensator.

According to an embodiment, a method of filling the battery system as described above is provided. The method includes filling the flexible membrane with a pressure that is between the first opening pressure and the second opening pressure. Thus, the battery system is brought into an operation state in which pressure force is provided on the battery cell stacks and which is within the hysteresis as described above.

The method may further include refilling the flexible membrane with a normal pressure that is between the first opening pressure and the second opening pressure when the pressure in the membrane drops below the first opening pressure. Thus, stable operation conditions can be maintained by a refilling process.

According to an embodiment, a vehicle including a battery system as described above is provided.

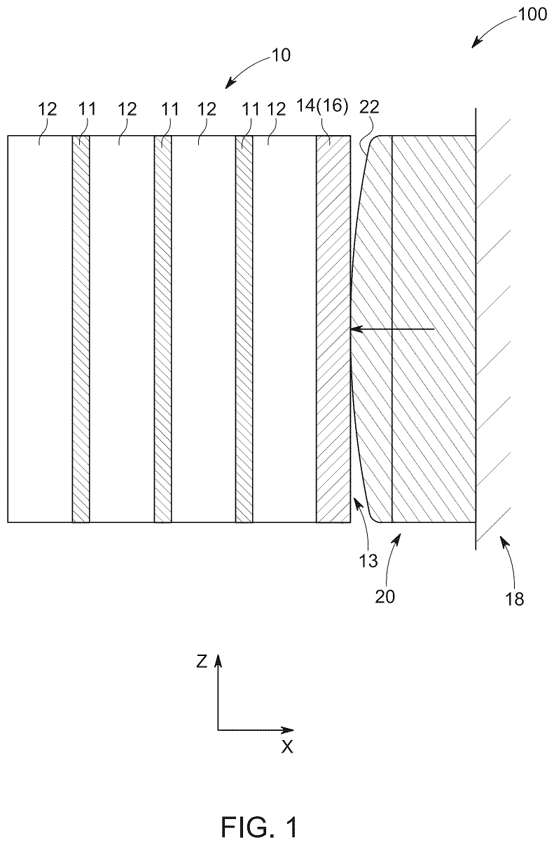

FIG. 1 is a schematic side view of a battery system 100 according to an embodiment. The battery system 100 includes at least one battery cell stack 10. The battery cell stack 10 includes a plurality of battery cells 12. For example, as shown in FIG. 1, the battery cells 12 may be prismatic battery cells, and they may be stacked accordingly. The battery cells 12 are accommodated in a compartment (or frame) 16 to form a battery module. From among the components of the compartment 16, only an end plate 14 is illustrated in FIG. 1. A plurality of spacers 11 may be provided between the battery cells 12, as illustrated in, for example, FIG. 1. Further, a housing 18 (only a side wall of which is shown in FIG. 1) may be provided in which the battery cell stack 10 is integrated (e.g., is accommodated). However, the positioning is not restricted to the boundary of the housing 18 shown in FIG. 1. The end plate 14 provides a boundary of the battery cell stack 10 while the other frame portions are not illustrated in the present schematic view.

The battery system 100 further includes at least one compensator 20. The compensator 20 is located at an end 13 of the battery cell stack 10. In the illustrated embodiment, the compensator 20 is provided at (e.g., on or adjacent to) the end plate 14 of the battery cell stack 10. In other embodiments, the compensator 20 may be disposed directly at a battery cell 12, for example, at a main surface thereof.

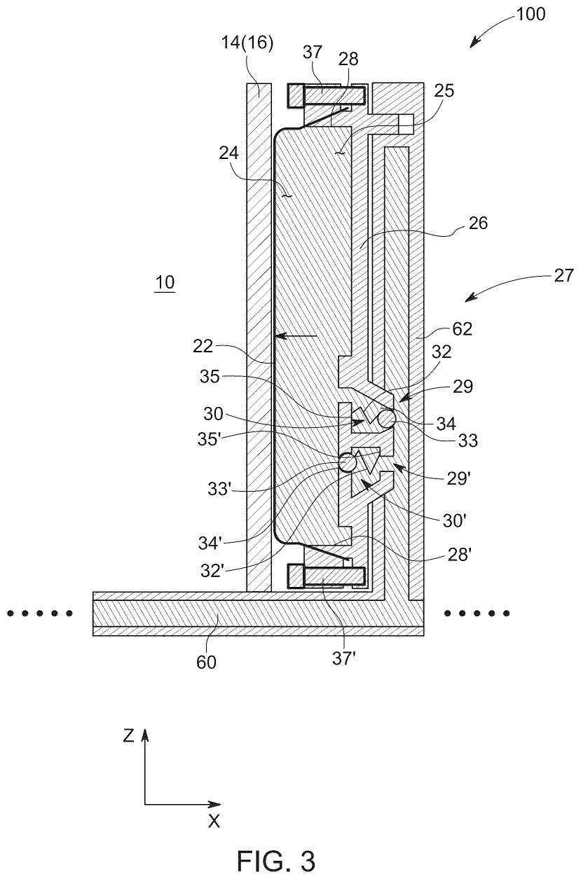

As illustrated in FIG. 1, the compensator 20 includes a flexible membrane 22. The flexible membrane 22 may be coupled to a membrane carrier 26 (see, e.g., FIGS. 3 to 5). The membrane carrier (or support) 26 may be located at the end 13, for example, at the end plate 14, of the battery cell stack 10. The flexible membrane 22, together with the membrane carrier 26, define a variable volume 24 that is filled with a fluid. For example, the fluid may be water, but the present disclosure is not limited thereto.

The flexible membrane 22 is configured to expand in response to the fluid pressure rising (or increasing) in the compensator 20. Thus, when the pressure increases in the compensator 20, the variable volume 24 of the compensator 20 increases. Similarly, the flexible membrane 22 contracts in response to the fluid pressure reducing (or decreasing) in the compensator 20. Thus, when the pressure decreases in the compensator 20, the variable volume 24 of the compensator 20 reduces. Accordingly, the compensator 20 is positioned at the end 13 of the battery cell stack 10 to exert a pressing force on the battery cell stack 10. The pressing force applied to the battery cell stack 10 depends on (or is controlled by) the fluid pressure in the compensator 20.

Due to the flexible membrane 22 and the pressure-sensitivity thereof, an adjustable pressure force can be applied to the battery cell stack 10 so that tolerances can be equalized by the fluid-containing compensator 20 including the flexible membrane 22 and swelling counterbalanced by the pressing force.

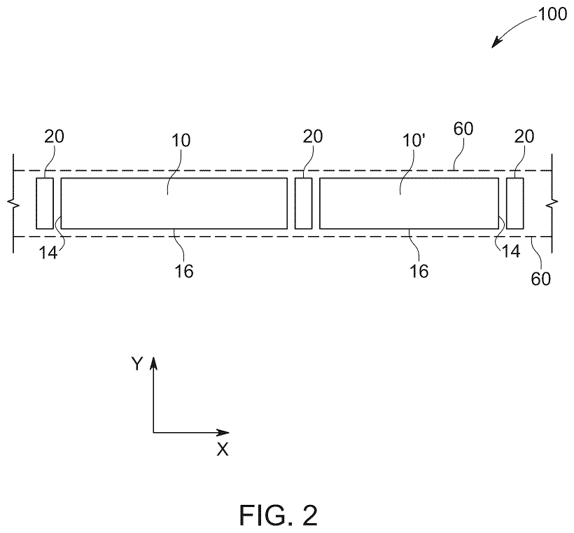

FIG. 2 is a schematic top view of a battery system 100 according to an embodiment. In this embodiment, the battery system 100 includes a plurality of compensators 20. The plurality of compensators 20 are fluid-connected with respect to each other (e.g., are in fluid communication with each other) by a fluid manifold 60, which is only schematically illustrated in FIG. 2. The compensators 20 may be positioned at end plates 14 or directly at one or more of the battery cells 12 at an end of a battery cell stack 10. Because the plurality of compensators 20 are fluid-connected with respect to each other by a fluid manifold 60, the compensation force between different battery cell stacks 10, 10′ can be equalized (e.g., can be equally applied).

Further, the fluid manifold 60, as illustrated in FIG. 2, may be a cooling manifold. Thus, the fluid may be a coolant liquid, such as water, but the present disclosure is not limited thereto. Accordingly, existing structures of the battery system 100 can be used for cooling and to provide the working fluid for the flexible membrane 22 and to exert the pressure force on the battery system 100. This increases compactness and retrofitabililty.

FIG. 3 is a schematic cross-sectional view of a battery system 100 including a compensator 20 according to an embodiment. The compensator 20 includes a fluid inlet 29. The fluid inlet 29 is formed in the membrane carrier (or membrane support) 26. The membrane carrier 26 includes a one-way inflow valve 30. The one-way inflow valve 30 is configured to allow fluid to flow into the flexible membrane 22 when a pressure difference across the fluid inlet 29 is above a first opening pressure. Further, the one-way inflow valve 30 is configured to prevent the fluid from flowing out of the flexible membrane 22 through the one-way valve 30.

Referring to FIG. 3, the fluid outlet 29′ includes, similar to above description of the fluid inlet 29, a one-way outflow valve 30′. The one-way outflow valve 30′ is configured to allow fluid to flow out of the flexible membrane 22 when a pressure difference across the fluid outlet 29′ is above a second opening pressure. Further, the one-way outflow valve 30′ is configured to prevent the fluid from flowing into the flexible membrane 22.

Further, as will be described in more detail below, the first opening pressure of the one-way inflow valve 30 is lower than the second opening pressure of the one-way outflow valve 30′. Thus, in this embodiment, the one-way valves 30, 30′ are configured differently and open according to the applied pressure; that is, the first opening pressure of the inlet one-way-valve 30 is lower than the second opening pressure of the outlet one-way valve valves 30′. Swelling of the battery cells 12 can be effectively relieved by creating a hysteresis effect, which will be described in more detail below.

The fluid in the flexible membrane 22 may have a pressure (e.g., a pressure value) between the first opening pressure and the second opening pressure, for example, as a target pressure of a filling process. In this case, the one-way inflow valve 30 is opened and the one-way outflow valve 30′ is closed. The compensator 20 is then in a pressure balance with the fluid manifold 60 and applies a pressing force onto the battery cell stack 10.

Further, when an overpressure is caused due to, for example, swelling of the battery cells 12 in the battery cell stack 10, the overpressure may be greater than the second opening pressure. In this case, excess pressure is relieved by the fluid outlet 29′ via the outlet one-way valve 30′ and distributed throughout the system. Thus, an over pressure protection is provided by accordingly setting the second opening pressure.

Further, when the swelling decreases again, the pressure within the compensator 20 will again be within the hysteresis, that is, the first opening pressure<current pressure<the second opening pressure, so that a default or normal state is reestablished. When the pressure in the battery cell stack 10 is below the first opening pressure, a refilling process may occur. Even if the filling pressure (e.g., the ambient pressure) is not present, the battery cell stack 10 would remain under compression due to the lower boundary (e.g., the first opening pressure) preventing an outflow of the fluid at a lower pressure, thereby retaining an amount (e.g., a low amount) of fluid in the membrane 22. This ensures that a residual pressure is exerted on the battery cell stack 10.

During normal operation, it is the normal setting to set the pressure of the fluid stack to be between the first opening pressure and the second opening pressure. To provide stable operation conditions, the difference between the first opening pressure and the second opening pressure should be made relatively large.

Thus, the configuration including the two one-way valves 30, 30′ facilitates length compensation in the battery cell stack 10 as well as compensation for the change in length during aging (e.g., due to swelling) or charging/discharging processes. Further, this configuration prevents overpressure due to the upper pressure bound and also retains a residual pressure so that even with no ambient pressure (e.g., no filling pressure), a pressing force is provided to the battery cell stack 10.

The above conditions may be present in FIG. 3. For example, each of the inflow and one-way outflow valves 30, 30′ is (or includes) a ball check valve. The ball check valve includes a spring 32, 32′ and a ball member 33, 33′ connected to the spring 32, 32′. The ball member 33, 33′ is configured to close the respective fluid inlet or fluid outlet 29, 29′ when the pressure difference is below the respective opening pressures.

The fluid inlet 29 and the fluid outlet 29′ may form chambers in which the ball check valve is integrated. For example, a constriction 34, 34′ may be provided in which the ball member 33, 33′ is pressed or seated by the spring 32, 32′. The spring 32, 32′ may be mounted at an opposing wall 35, 35′ in the chamber opposite to the constriction 34, 34′ to provide an elastic pressing force against the constricted opening. As described above, the spring 32 may have a lower stiffness than the spring 32′, as an example, to provide the relative opening pressures as described above to create the hysteresis.

In addition, the flexible membrane 22 is fixed to the membrane carrier 26. For example, ends of the flexible membrane 22 may be coupled to the membrane carrier 26 by a bolt or screw 37, 37′.

Further, the fluid inlet and the fluid outlet 29, 29′ are provided in a side wall 27 of the membrane carrier 26. Further, the fluid manifold 60 includes a vertical connecting section 62, which is fluid connected to the fluid inlet and the fluid outlet 29, 29′. Thus, a horizontal inlet is provided that uses lateral space to provide stable connection for the inlet and outlet one-way valves 30, 30′.

In addition, the membrane carrier 26 includes two protruding portions 28, 28′ protruding toward the battery cell stack 10 and being separated from each other in a height direction (e.g., the z-direction). The flexible membrane 22 is coupled to the membrane carrier 26 so that the fluid is filled in the variable volume 24 of the flexible membrane 22 and in a fixed space 25 formed between the protruding portions 28, 28′. Thus, the flexible membrane 22 only has to cover a half-space (e.g., only has to cover half the lateral size of the compensator 20) and is stably supported by the membrane carrier 26. In addition, a more homogeneous pressure force can be applied to the corresponding battery cell stack 10, 10′, in other words, the curvature of the flexible membrane 22 may be smaller. Thus, a larger (side) area of the battery cell stack 10, 10′ receives a pressing force to improve the effective contact.

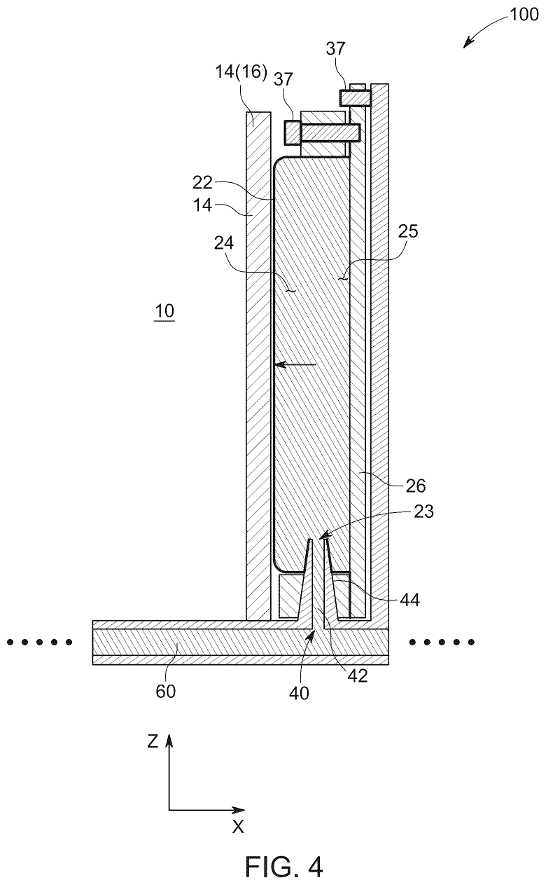

FIG. 4 is a schematic cross-sectional view of a battery system 100 according to another embodiment of the compensator 20. In this embodiment, the differences with respect to the embodiment shown in FIG. 3 are primarily described.

The compensator 20 includes a vertical inlet 40 (e.g., extending in a height direction of the battery cell stack 10, 10′) located between the fluid manifold 60 and the flexible membrane 22. For example, the fluid manifold 60 is formed below the battery cell stack 10, 10′. The vertical inlet 40 includes a direct channel 42 connecting the fluid manifold 60 with the flexible membrane 22. In this embodiment, a membrane opening 23 is provided in the vertical inlet 40 to let fluid pass and enter the variable volume 24. Thus, in this embodiment, no additional valves are used. Because the vertical inlet 40 includes a direct channel 42 to the interior of the flexible membrane 22, an overpressure is directly and automatically regulated. Thus, when a pressure of the battery cell stack 10, 10′ rises, any over pressure is directly released and distributed. Further, due to the vertical inlet 40, a lateral space can be reduced to allow compact integration. In addition, pressure regulation of overpressure in a battery cell stack 10, 10′ is directly distributed over the entire fluid system without requiring a valve. Further, in the embodiment shown in FIG. 4, the vertical inlet 40 has a cone shape 44. This cone (or cone-shaped surface) 44 ensures a tight seal when a pressure force is applied.

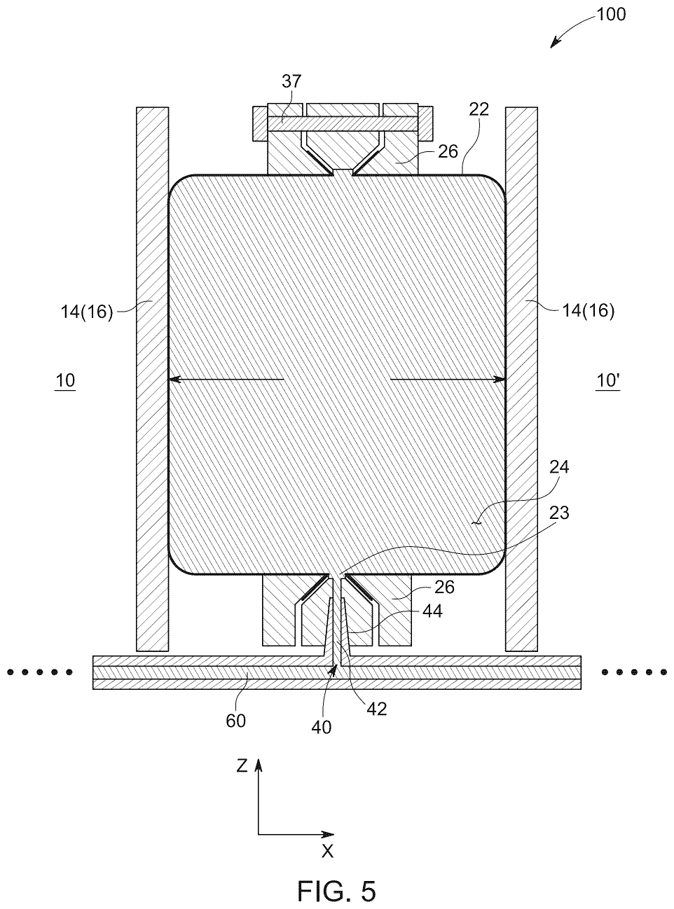

FIG. 5 is a schematic cross-sectional view of a battery system 100 according to another embodiment. The compensator 20, in this embodiment, is located between two ends 13 of adjacent battery cell stacks 10, 10 so that the flexible membrane 22 exerts a pressing force on both battery cell stacks 10, 10′ based on the fluid pressure in the flexible membrane 22. In this embodiment, the membrane carrier 26 can be centrally disposed between the end plates 14. Thus, a pressure force may be applied to both battery cell stacks 10, 10′, as illustrated in FIG. 5. Similar to the embodiment shown in FIG. 4, a vertical inlet 40 is provided. However, in other embodiments, the features described above with respect to FIG. 3 can be provided for the central positioning to apply a pressure force in both directions. The end plates 14 are provided but the compensator 20 may also be in direct contact with a main surface of a battery cell 12.

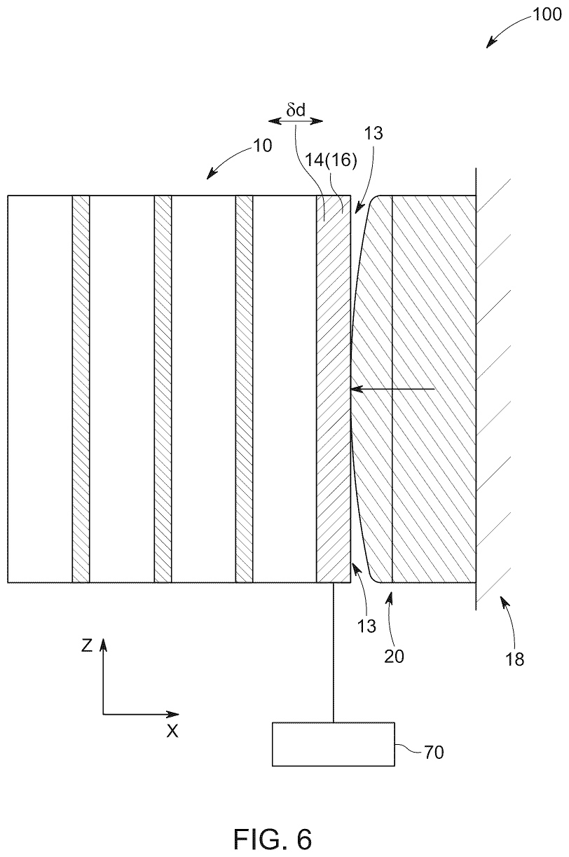

FIG. 6 is a schematic side view of a battery system 100 according to another embodiment. In this embodiment, the differences with respect to the embodiment shown in FIG. 1 are primarily explained. In this embodiment, the end plate 14 is installed to be movable with respect to the compensator 20. Thus, the end plates 14 can be guided. For example, as illustrated in FIG. 6, a linear displacement ad of the end plate 14 may be controlled. This allows a constant pressure force to be set across the area (e.g., the main area) of the battery cell stacks 10, 10′. For example, a more homogeneous pressure can be provided by adjusting the relative position of the end plate 14 with respect to the compensator 20, that is, the curved membrane 22 may more smoothly and/or completely contact the end of the battery cell stack 10.

A position control unit 70 may be configured to adjust the position (by displacement) of the end plate 14 with respect to the compensator 20. For example, the adjustment may be based on a detected pressure force across an area of the battery cell stack 10 or by determining the contact area between the flexible membrane 22 with the area (e.g., the main area) of the battery cell stack 10, 10′. Thus, force transmission can be optimized and can be combined with any of the above-described embodiments.

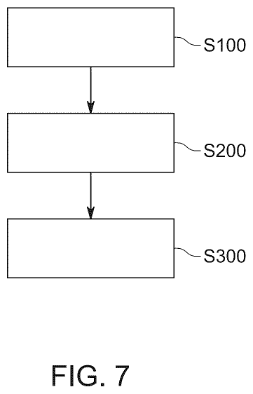

FIG. 7 is a flowchart describing a method of filling the battery system 100 according to an embodiment. The method includes providing a battery system 100 including a compensator 20 (S100). The battery system 100 may be as described above with respect to FIG. 3 and may include the one-way inflow-valve 30 and the one-way outflow-valve 30′.

The method further includes filling the compensator 20 with a pressure between the first opening pressure (of the one-way inflow-valve 30) and the second opening pressure (of the one-way outflow-valve 30′) (S200). Thus, a normal operation state of the battery system 100 is provided as described above with respect to FIG. 3, and each battery cell stack 10, 10′ is placed under compression force.

The method may further include refilling the compensator 20 with the pressure between the first opening pressure and the second opening pressure (S300). This is performed when the pressure in the compensator 20 caused by the battery cell stack 10, 10′ drops below the first opening pressure. A pressure sensor may be used to monitor the pressure and to activate a pump/refill mechanism to reestablish the normal operating state.

Thus, this method ensures that the battery system 100 maintains the normal/working state and the battery cell stacks 10, 10′ remain under compression pressure. For example, pressure control by the pressure sensor may be performed to automatically detect when to refill and to cause a pump for reestablishing the pressure force acting on the battery cell stacks 10, 10′.

In summary, a battery system 100, according to various embodiments, is provided with at least one compensator 20 that can apply a compression force on at least one battery cell stack 10, 10′ by using fluid pressure. This mechanism allows for tolerance equalizing and swelling compensation. According to various embodiments, the compression is provided via multiple connected compensators. This allows for coherent compression of even different battery cell stacks 10, 10′ and improves operability of the battery system 100.

Some Reference Symbols

| | | | |
|---|---|---|---|
| 100 | battery system | 10 | battery cell stack |
| 10' | battery cell stack | 11 | spacer |
| 12 | battery cells | 13 | end |
| 14 | end plate | 16 | compartment |
| 18 | housing / housing wall | 20 | compensator |
| 22 | flexible membrane | 23 | membrane opening |
| 24 | variable volume | 25 | fixed space |
| 26 | membrane carrier | 27 | side wall |
| 28 | protruding portion | 28' | protruding portion |
| 29 | fluid inlet | 29' | fluid outlet |
| 30 | one-way inflow-valve | 30 | one-way outflow-valve |
| 32 | spring | 32' | spring |
| 33 | ball member | 33' | ball member |
| 34 | constriction | 34' | constriction |
| 35 | opposing wall | 35' | opposing wall |
| 37 | bolt/screw | 37' | bolt/screw |
| 40 | vertical inlet | 42 | direct channel |
| 44 | cone | 60 | fluid manifold |
| 62 | vertical connecting section | 70 | position control unit |
| S100 | providing | S200 | filling |
| S300 | refilling | | |

What is claimed is:

1. A battery system comprising:
a battery cell stack comprising a plurality of battery cells accommodated in a compartment; and
a compensator at an end of the battery cell stack to exert a pressing force on the battery cell stack, the compensator comprising a flexible membrane coupled to a membrane carrier to define a variable volume that is configured to be filled with a fluid,
wherein the flexible membrane is configured to expand in response to a fluid pressure rising in the compensator and contract in response to the fluid pressure reducing in the compensator.

2. The battery system as claimed in claim 1, further comprising:
a plurality of the compensators; and
a fluid manifold fluid-connecting the compensators with each other.

3. The battery system as claimed in claim 2, wherein the fluid manifold comprises a cooling plate fluid-connected with the compensators.

4. The battery system as claimed in claim 1, wherein the compensator comprises:
a fluid inlet comprising a one-way inflow valve configured to allow fluid to flow into the flexible membrane when a pressure difference across the fluid inlet is above a first opening pressure; and
a fluid outlet comprising a one-way outflow valve configured to allow fluid to flow out of the flexible membrane when a pressure difference across the fluid outlet is above a second opening pressure,
wherein the first opening pressure of the one-way inflow valve is lower than the second opening pressure of the one-way outflow valve.

5. The battery system as claimed in claim 4, wherein a normal filling pressure is a value between the first opening pressure and the second opening pressure.

6. The battery system as claimed in claim 4, wherein each of the inflow and one-way outflow valves comprises a ball check valve comprising a spring and a ball member connected to the spring, and
wherein the ball member is configured to close the respective fluid inlet or fluid outlet when the pressure difference is below the respective opening pressure.

7. The battery system as claimed in claim 4, wherein the fluid inlet and the fluid outlet are in a side wall of the membrane carrier, and
wherein a fluid manifold comprises a vertical connecting section that is fluid-connected to the fluid inlet and the fluid outlet.

8. The battery system as claimed in claim 1, wherein the compensator comprises a vertical inlet between a fluid manifold and the flexible membrane, and
wherein the vertical inlet comprises a direct channel connecting the fluid manifold with the flexible membrane.

9. The battery system as claimed in claim 8, wherein the vertical inlet has a cone shape.

10. The battery system as claimed in claim 1, wherein the membrane carrier has two protruding portions separated in a height direction and protruding toward the battery cell stack, and
wherein the flexible membrane is coupled to the membrane carrier so that the fluid is filled in the variable volume of the flexible membrane and in a fixed space formed between the protruding portions.

11. The battery system as claimed in claim 1, wherein an end plate is at the end of the battery cell stack, and
wherein the end plate is configured to be movable with respect to the compensator.

12. The battery system as claimed in claim 11, further comprising a position control unit configured to adjust a position of the end plate with respect to the compensator.

13. A method of compensating a battery system comprising: a battery cell stack comprising a plurality of battery cells accommodated in a compartment; and a compensator at an end of the battery cell stack to exert a pressing force on the battery cell stack, the method comprising filling a flexible membrane of the compensator with a pressure between a first opening pressure and a second opening pressure.

14. The method of as claimed in claim 13, further comprising refilling the compensator with the pressure between the first opening pressure and the second opening pressure when the pressure in the flexible membrane drops below the first opening pressure.

15. A vehicle comprising the battery system as claimed in claim 1.
